(19) United States
(12) Patent Application Publication
(10) Pub. No.: US 2004/0038564 A1
(43) Pub. Date: Feb. 26, 2004

(54) Electrical connector

(76) Inventor: Bi-Jian Yan, Hong Kong (CN)

Correspondence Address: MOLEX INCORPORATED, 2222 WELLINGTON COURT, LISLE, IL, 60532, US

(21) Appl. No.: 10/464,388

(22) Filed: Jun. 18, 2003

(30) Foreign Application Priority Data
Jun. 21, 2002 (TW) 91209404

(51) Int. Cl. H01R 12/00

(52) U.S. Cl. 439/76.1

(57) ABSTRACT

An electrical connector comprising an insulative housing having a plurality of terminals received within the insulative housing, each terminal having a contact end, at least one circuit substrate having a first end, a second end and a plurality of conductive traces extending from the first end to the second end of the circuit substrate, the tail end of each of the terminals is terminated to the first end of each of the conductive traces, and a cable having a plurality of transmission wires terminated to the second end of the conductive traces so that the cable can be electrically connected with the terminals through the circuit substrate. In addition, the electrical connector may be part of a cable assembly.

### FIELD OF THE INVENTION

The present invention relates to an electrical connector, and more particularly to an electrical connector that uses a printed circuit substrate between the tail end of the connector terminals and the transmission wires of a cable terminated to the connector.

### BACKGROUND OF THE INVENTION

Please refer to FIG. 1 which illustrates one prior art approach to an electrical connector, the electrical connector includes an insulative housing 10a, a plurality of terminals 11a received in the insulative housing 10a, a shell 12a made of a metal material and covered on the insulative housing 10a, and a cable 13a having a plurality of transmission wires 14a, wherein the transmission wires 14a may constitute a pair of electrical wires twisted to each other, the transmission wires 14a respectively terminated to rear ends of the terminals 11a. The cable 13a has a covering layer 17a at an exterior thereof and covers an exterior of the transmission wires 14a.

Furthermore, the electrical connector of the prior art can further include an external shell 15a made of a metal material and an external sheath 16a made of a plastic material, which is covered by an exterior of a connection portion between the transmission wires 14a and the terminals 11a, for protecting the connection portion between the transmission wires 14a and the terminals 11a.

The electrical connector can be used for engaging a mating connector each other, so that the mating connector can be electrically contacted with the terminals 11a and enable the mating connector be electrically connected with the cable 13a for transmitting an electronic signal.

The transmission wires 14a generally each are a dual-twisted cord, i.e. each transmission wire 14a is constituted by two electrical wires twisted to each other. By a design of the dual-twisted cord, it can enable differential signals to be offset, and effectively reduce an interference of the “cross-talk” of the transmission wire 14a as transmitting signal and can decrease the signal noise.

When the cable 13a will be terminated to the terminals 11a, it must previously proceed to expose the wire, i.e. the covering layer 17a of the interior of the cable 13a will be removed off at a longer length, so that one end of the transmission wire 14a can be exposed the longer length so that it can be terminated successfully on the terminals 11a.

However, in above prior art, after the cable 13a is proceeded to expose wires, the design of the dual-twisted cord of an exposed portion of the transmission wire 14a will not be capable of shielding cross-talk as effectively, thus the transmission wire 14a fails to effectively reduce the interference of the cross-talk, with a resulting increase in the signal noise.

### SUMMARY OF THE INVENTION

The primary purpose of the present invention is to provide an electrical connector having a circuit substrate arranged between terminals and a cable, wherein transmission wires of the cable do not need to be directly terminated to the terminals, so that the transmission wires can be terminated on the circuit substrate, hence the length of exposed wire can be shortened substantially, and prevent dual-twisted cord of the transmission wire from being destroyed, thereby to reduce an interference of the cross-talk and decrease the signal noise.

In accordance with one aspect of the present invention, to provide an electrical connector comprising an insulative housing having a plurality of terminals received within the insulative housing, each terminal having a contact end, at least one circuit substrate having a first end, a second end and a plurality of conductive traces extending from the first end to the second end of the circuit substrate, the tail end of each of the terminals is terminated to the first end of each of the conductive traces, and a cable having a plurality of transmission wires terminated to the second end of the conductive traces so that the cable can be electrically connected with the terminals through the circuit substrate.

In another embodiment, the circuit substrate is a printed circuit board.

In yet another embodiment, the terminals are received within contact receiving cavities extending between a front end and a rear end of the insulative housing.

In a further embodiment, the electrical connector is part of a cable assembly.

Further embodiments of the invention are detailed in the foregoing detailed description of the disclosed embodiments and the appended claims.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 is a cross-sectional view of an electrical connector due to a prior art;

FIG. 2 is an exploded perspective view of an electrical connector due to the present invention;

FIG. 3 is a perspective view of the electrical connector due to the present invention;

FIG. 4 is a cross-sectional view of the electrical connector due to the present invention;

FIG. 5 is a partial cross-sectional view of a circuit board of the electrical connector due to an embodiment of the present invention; and

FIG. 6 is a partial cross-sectional view of a circuit board of the electrical connector due to another embodiment of the present invention.

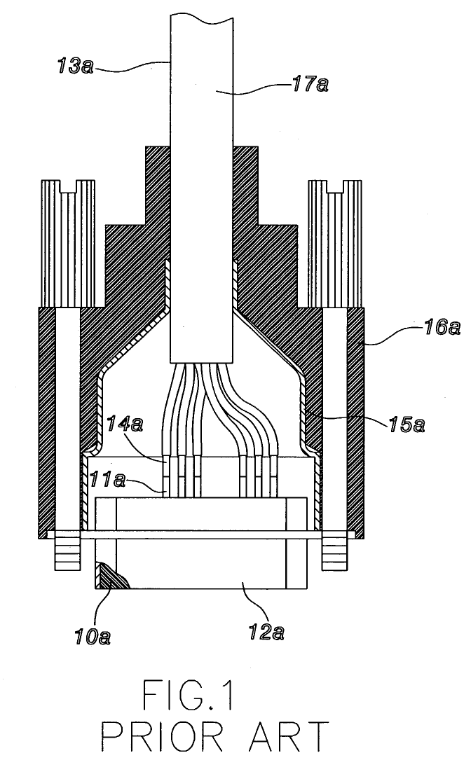

### DETAILED DESCRIPTION OF THE DISCLOSED EMBODIMENTS

While the invention may be susceptible to embodiment in different forms, there is shown in the drawings, and herein will be described in detail, a specific embodiment with the understanding that the present disclosure is to be considered an exemplification of the principles of the invention, and is not intended to limit the invention to that as illustrated and described herein.

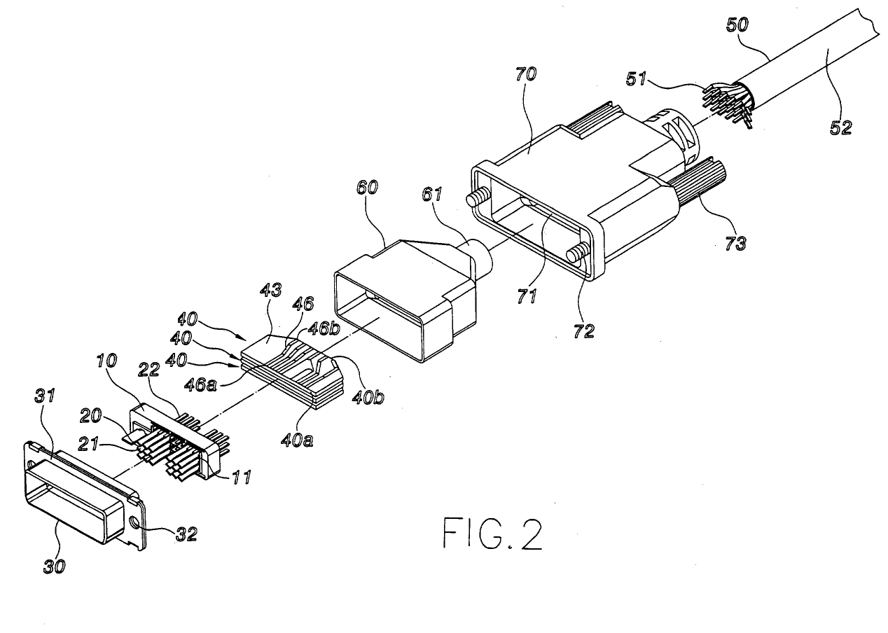

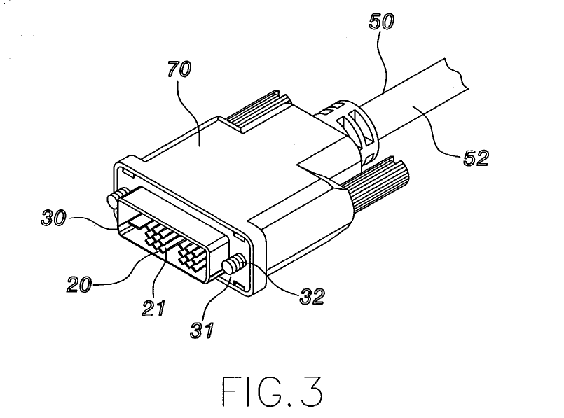

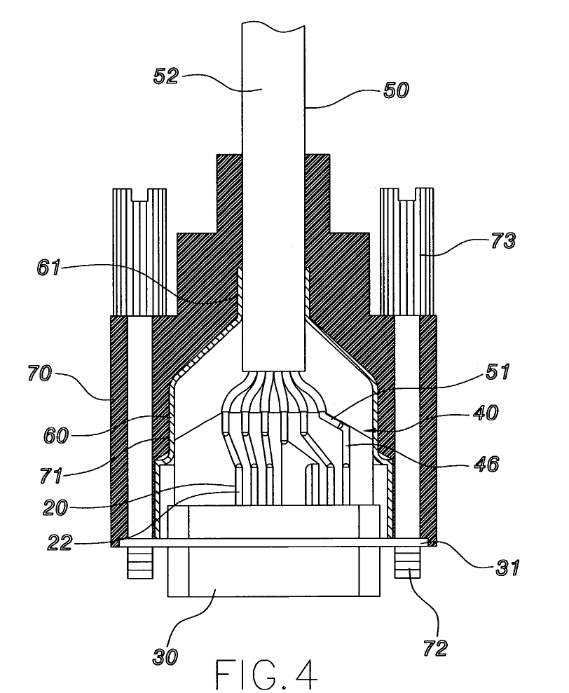

Referring to FIGS. 2 to 4, the present invention provides an electrical connector which includes an insulative housing 10, a plurality of terminals 20, at least one circuit substrate, preferably a printed circuit board, 40 and a cable 50, wherein the insulative housing 10 is a substantially rectangular body made of a plastic material, the insulative housing 10 having a plurality of contact receiving cavities 11 extending from a front end to a rear end of the insulative housing 10. Optionally, the electrical connector may include a metallic shield 30.

The plurality of terminals 20 each are made of an electrically conductive material and have a contact end 21 and a tail end 22, and the plurality of terminals 20 respectively are received in the contact receiving cavities 11, so that the tail end 22 and contact end 21 of each of the terminals 20 respectively project to the front end and rear ends of the housing 10 and can be electrically connected with a mating connector and the circuit board 40.

The metallic shield 30 is made of well-shielded metal material, and the metallic shield 30 can be a hollow casing and covering an exterior of the housing 10, for providing a protecting, i.e., shielding, effect. The metallic shield 30 has a plate element 31 extended from an outer wall thereof, and the plate element 31 has two holes 32 formed adjacent to two sides thereof.

The circuit board 40 is disposed a rear of the housing 10, however, this embodiment defines three circuit boards 40, but the number of the circuit boards can be properly decided according to the number and arrangement of the terminals 20 and transmission wires 51 of the cable 50. The circuit boards 40 each have a substrate 41 (as shown in FIG. 5), a ground layer 42 of a metallic material arranged on the substrate 41 and an insulative layer 43 arranged on the ground layer 42, and an electric-conducting layer 44 arranged on the insulative layer 43, wherein the electric-conducting layer 44 has a plurality of separated spaces 45 by an etching manner, thereby to be formed as a plurality of conductive traces 46 arranged on the insulative layer 43 and extending from a first end 40a to a second end 40b of the circuit board, and the conductive traces 46 are corresponding to the transmission wires 51 of the cable 50. The tail end 22 of the terminals 20 is terminated on one end (front end) 46a of the conductive traces 46 of the circuit boards 40, for enabling the terminals 20 to achieve an electrical connection with the circuit boards 40.

The cable 50 each have a plurality of transmission wires 51, each can be a dual-twisting cord, by a design of the dual-twisted cord, it enables differential signals be offset, effectively reduce an interference of the “cross-talk” of and can decrease the signal noise. The cable 50 each have a covering layer 52 covered around an exterior of the transmission wires 51, when the transmission wire 51 will be connected with the circuit boards 40, the cable 50 must previously proceed to peel wire, so that the covering layer 52 of the cable 50 will be peeled off a length, one end of each of the transmission wires 51 can be exposed with a proper length, and the transmission wires 51 each have an exposing end to be terminated on another end (rear end) 46b of each of the conductive traces 46 of the circuit board 40, whereby the cable 50 can be electrically connected with the terminals 20 through the circuit board 40.

The electrical connector may further comprises an external shell 60 and an external sheath 70 are covered around an exterior of a connected portion between each of the transmission wires 51 and the tail ends 22 of the terminals 20, for protecting the connected portion between the transmission wires 51 and the terminals 20.

The external shell 60 can be a hollow casing made of a well-shielding metal material and covers on an exterior of a rear-half portion of the housing 10 for providing a shield-protecting effect. The external shell 60 has a sleeve 61 at a rear end thereof, for connecting on an end of the cable 50, and the external shell 60a has a front end connected against a rear end of the plate element 31 of the metallic shield 30. By the connected portion between each of the transmission wires 51 and the tail ends 22 of the terminals 20, and the circuit board 40 sealed in an interior of the external shell 60, it can provide a preferred shield-protecting effect.

The external sheath 70 is made of a plastic material having a received space 71 defining a shape according to that of the external shell 60, so that the external sheath 70 can be covered on an exterior of the external shell 60. The external sheath 70 has two screws 72 at two sides thereof, and the screws 72 has a knob 73 at its rear end so as to turn the screws 72, wherein the two screws 72 project to a proper length of a front end of the plate element 31 through two holes 32 of the metallic shield 30, when the electrical connector is engaged with a mating connector, it can be fixed by the two screws 72, so that the electrical connector can be securely connected with the mating connector together.

The present invention mainly discloses the circuit boards 40 arranged between the terminals 20 and the cable 50, and the plurality of conductive traces 46 formed on the circuit boards 40, for terminating to the transmission wires 51 of the cable 50 and the tail ends 22 of the terminals 20. Because the transmission wires 51 of the cable 50 are not directly terminated to the tail ends 22 of the terminals 20, but terminated to the circuit board 40, hence a length of the exposed wire can be shortened substantially, the length of the cable 50 is about 20%˜30% of that of the prior art in the preferred embodiment. Whereby, the length of the exposed wire of the cable 50 can be shortened substantially, thereby to prevent the dual-twisted cord of the transmission wire from being destroyed, and reduce an interference of the “cross-talk” and decrease the signal noise.

Furthermore, the present invention discloses the ground layer 42 arranged under the conductive traces 46 of the circuit board 40 for providing a ground effect, hence the signal interference between the transmission wires 51 can be absorbed, and reduce the interference of the “cross-talk” and decrease the signal noise between the transmission wires 51.

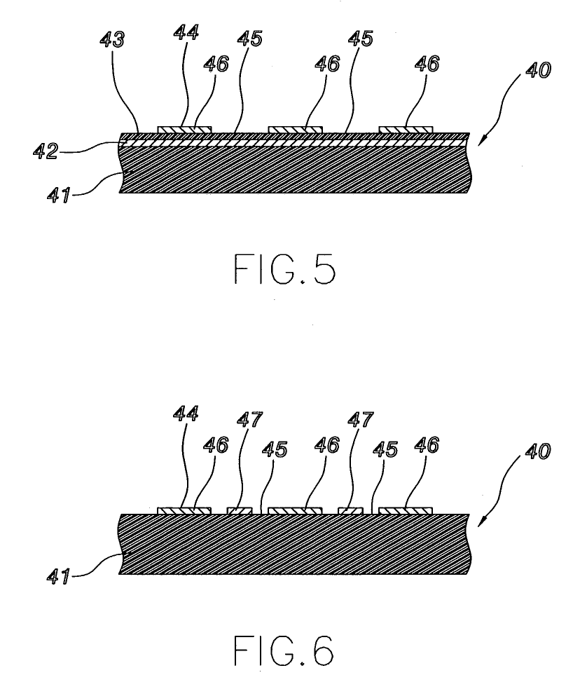

Additionally, please refer to FIG. 6, the present invention also can disclose a plurality of ground wires 47 arranged between the conductive traces 46 of the circuit board 40 for replacing the ground layer 42, i.e. the electric-conducting layer 44 can be directly arranged on the substrate 41 of the circuit board 40, wherein the electric-conducting layer 44 has a plurality of separated spaces 45 by an etching manner, thereby to be formed as a plurality of conductive traces 46, and the ground wires 47 arranged in the separated spaces 45, whereby the ground wires 47 can be arranged between the conductive traces 46, and have the ground effect, hence the signal interference between the transmission wires 51 can be absorbed and reduce the interference of the “cross-talk” and decrease the signal noise between the transmission wires 51.

While a preferred embodiment of the present invention is shown and described, it is envisioned that those skilled in the art may devise various modifications of the present invention without departing from the spirit and scope of the appended claims. Accordingly, the above disclosure should be construed as limited only by the metes and bounds of the appended claims.

1. An electrical connector for terminating to a cable having a plurality of transmission wires, the electrical connector comprising
an insulative housing;
a plurality of terminals received within the insulative housing, each terminal having a contact end and a tail end; and
at least one circuit substrate, the circuit substrate having a first end, a second end and a plurality of conductive traces extending from the first end to the second end of the circuit substrate, wherein the tail end of each of the terminals is terminated to a conductive trace located on one end of the circuit substrate, and the transmission wires each being capable of being terminated to conductive traces on the second end of the circuit substrate so that the cable can be electrically connected with the terminals through the circuit substrate.

2. The electrical connector as claimed in claim 1, wherein the circuit substrate is a printed circuit board.

3. The electrical connector as claimed in claim 1, wherein the insulative housing includes a front end and a rear end, the contact receiving cavities extending between the front end and the rear end of the insulative housing, and the tail end of the terminals extending from the rear end of the insulative housing.

4. The electrical connector as claimed in claim 2, wherein the circuit board has a substrate, a ground layer of a metallic material arranged on the substrate and an insulative layer arranged on the ground layer, and the conductive traces arranged on the insulative layer.

5. The electrical connector as claimed in claim 2, wherein the circuit board has a substrate, and the conductive traces arranged on the substrate, a ground wire arranged between the conductive traces.

6. The electrical connector as claimed in claim 1, wherein the transmission wire is a dual-twisting cord.

7. The electrical connector as claimed in claim 1, wherein a metallic shield substantially covers an exterior surface of the insulative housing.

8. The electrical connector as claimed in claim 1, further comprising an external shell and an external sheath are covered around an exterior of a connected portion between each of the transmission wires and the tail ends of the terminals.

9. The electrical connector as claimed in claim 8, wherein the external shell has a sleeve at a rear end thereof, for connecting on an end of the cable, and the external shell is covered on an exterior of a rear-half portion of the housing.

10. The electrical connector as claimed in claim 8, wherein the external sheath is covered on an exterior of the external shell and has two screws at two sides thereof, and the screws each have a knob.

11. The electrical connector as claimed in claim 1, wherein the tail end of the terminals projected from an end of the insulative housing.

12. The electrical connector as claimed in claim 1, wherein the insulative housing includes a plurality of contact receiving cavities and wherein each of the plurality of terminals is received in one of the plurality of contact receiving cavities.

13. A cable assembly, comprising:
at least one electrical connector and a cable terminated to the electrical connector, wherein the electrical connector comprises an insulative housing, a plurality of terminals received within the insulative housing, each terminal having a contact end and a tail end, and at least one circuit substrate, the circuit substrate having a first end, a second end and a plurality of conductive traces extending from the first end to the second end of the circuit substrate, wherein the tail end of each of the terminals is terminated to a conductive trace located on the first end of the circuit substrate; and
wherein the cable includes a plurality of transmission wires, the transmission wires being terminated to conductive traces located on the second end of the circuit substrate so that the cable can be electrically connected with the terminals through the circuit substrate.

14. The cable assembly as claimed in claim 13, wherein the tail end of the terminals projected from an end of the insulative housing.

15. The cable assembly as claimed in claim 13, wherein the insulative housing includes a plurality of contact receiving cavities and wherein each of the plurality of terminals is received in one of the plurality of contact receiving cavities.

16. The cable assembly as claimed in claim 13, wherein the circuit substrate is a printed circuit board.

17. The cable assembly as claimed in claim 13, wherein the insulative housing includes a front end and a rear end and a plurality of contact receiving cavities extending between the front end and the rear end of the insulative housing, wherein the tail end of the terminals extend from the rear end of the insulative housing.

18. The cable assembly as claimed in claim 16, wherein the circuit board has a substrate, a ground layer of a metallic material arranged on the substrate and an insulative layer arranged on the ground layer, and the conductive traces arranged on the insulative layer.

19. The cable assembly as claimed in claim 16, wherein the circuit board has a substrate, and the conductive traces arranged on the substrate, a ground wire arranged between the conductive traces.

20. The cable assembly as claimed in claim 13, wherein the transmission wire is a dual-twisting cord.
